(19) United States
(12) Patent Application Publication
(10) Pub. No.: US 2001/0047691 A1
(43) Pub. Date: Dec. 6, 2001

(54) Hybrid transient-parametric method and system to distinguish and analyze sources of acoustic emission for nondestructive inspection and structural health monitoring

(76) Inventor: Yuris Dzenis, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/754,020

(22) Filed: Jan. 3, 2001

Related U.S. Application Data
(60) Provisional application No. 60/174,215, filed on Jan. 3, 2000.

(51) Int. Cl. G01N 29/00; G01H 1/00

(52) U.S. Cl. 73/587

(57) ABSTRACT

A nondestructive evaluation (NDE) technique for inspecting or health monitoring of structures and/or specimens by analyzing acoustic emission (AE) signals emitted by the structures and/or specimens. The method and system analyzes acoustic emission (AE) signals emitted by structures and/or specimens. AE signals emitted by the structures and/or specimens are parametrically filtered as a function of parametric filters corresponding to characteristic waveforms of transient AE classes of predefined AE signals. In parametric analysis, the filtering may be pre- or post-recording. In transient AE analysis, the filtering may be prior to transient recording of the transient signals.

### FIELD OF THE INVENTION

The invention generally relates to a method and apparatus for inspecting and/or monitoring changes in structures and/or specimens and, in particular, a nondestructive evaluation (NDE) technique for inspecting or health monitoring of structures and/or specimens by analyzing acoustic emission (AE) signals emitted by the structures and/or specimens.

### BACKGROUND OF THE INVENTION

Nondestructive evaluation (NDE) of specimens and structures has become very important in anticipating, determining, minimizing and/or preventing problems. For example, real time NDE and monitoring of structures is important to prevent failures and to permit timely maintenance, repair and/or replacement. Analysis of acoustic emission (AE) signals from specimens and structures has been one method of conducting NDE and inspection. The analysis of AE signals provides high sensitivity to damage or other change of conditions and, in particular, provides the capability to evaluate specimens and structure in real time so that the damage or other changes in structural integrity can be detected and corrected before a catastrophic failure.

The following discussion on the damage in materials is used as an example of the application of AE for NDE. Two approaches to acoustic emission analysis have been developed: parametric AE analysis and transient AE analysis. In the past, evaluation of damage and fracture development in structures and/or specimens was performed by the parametric method. This method is based on the extraction of a number of parameters and/or features from individual AE signals. A typical AE signal is shown in FIG. 1. Some of the AE parameters and/or features are defined in FIG. 1 including signal amplitude, duration, rise time, decay time, and AE counts. Other parameters and/or features can be defined, for example average frequency, energy etc. Flags related to the signal shape, such as a multipeak flag, can also be defined.

Parametric AE analysis has been used to evaluate overall damage accumulation in materials. It has been found that the AE rate generally is correlated with the rate of stiffness reduction due to damage. Numerous attempts have been made to identify sources of the AE signals in materials. Different damage mechanisms were expected to produce AE signals with different AE parameters. Energy discrimination was used. However, the attempts to apply single parameter filtering (single AE parameter threshold) to separate the damage mechanisms were largely unsuccessful due to overlap of the parametric ranges for different damage mechanisms. This parametric overlap is often caused by the complexity and randomness of the damage process in structures and/or specimens. Similar microcracks do not occur simultaneously in all the similar microvolumes of certain materials because the local microstructures and stress exhibit considerable variations. Similarly, the waves created by the microcracks of the same type are not necessarily the same. Variations in the crack location and orientation and complexity of the wave propagation process in materials further increase AE signal variability. Multiple reflections from internal and external boundaries and the associated mode conversions alter the source wave and change the AE parameters that are detected.

All of the above results in statistical distributions of the AE parameters, even for the signals produced by similar damage events. Depending on the type of damage and the width of these distributions, the AE from certain structures and specimens can sometimes result in AE parameter distribution exhibiting multiple peaks. Similarly, multiple clusters of signals (dense areas) can sometimes be on the AE parameter correlation plots. However, in practice, these multipeak distributions and clusters are rarely observed. Overall, the parametric AE analysis is capable of providing useful information on damage development. However, the discrimination of damage mechanisms by this method is difficult to achieve due to the overlap of AE parameters caused by the complex damage and wave propagation processes.

An alternative to parametric analysis is transient AE analysis for AE source recognition. Methods of pattern recognition analysis and neural networks were used for AE signal classifications. It has been shown that the characteristic signal shapes can be present in the overall AE signals and that these waveshapes can be associated with particular damage mechanisms. These recent results showed that the transient AE analysis method may provide more powerful and robust capability to discriminate between the damage mechanisms based on the full waveform analysis. A disadvantage of this method for the damage analysis in materials is the large amount of data that has to be acquired and analyzed. Certain structures and specimens typically accumulate a large number of damage events of different types. This is especially true for structures and/or specimens subject to long-term loads such as loads which cause fatigue. The acquisition, storage, and analysis of full waveforms for all these signals is either impossible or impractical. In addition, the automated signal classification is not an easy task. It requires a thorough understanding of the classification algorithms and should generally be performed by experienced personnel.

Thus, the parametric and transient methods of AE analysis have advantages and disadvantages, particularly in regard to inspection and/or damage evolution studies in structures and/or specimens. Modern AE systems can provide both transient and parametric analysis capabilities. Such systems perform transient and parametric data acquisition simultaneously. The results are recorded in two data files, the parametric AE file and the transient AE file. Some systems have a capability to relate the transient records to the parametric records, thus providing means for simultaneous transient-parametric analysis. Such an analysis could theoretically combine the power of transient classification and the simplicity of parametric filtering. It would seem especially advantageous for studies of damage evolution in structures and/or specimens.

There is a need for a system and method to perform the transient analysis and/or source identification once and then have a simple tool to distinguish and extract histories of AE from different sources. As histories are preferably extracted and/or analyzed in parametric format, it would seem that a hybrid method would be preferable.

### SUMMARY OF THE INVENTION

In general, the invention comprises a method of analyzing acoustic emission (AE) signals emitted by a structure and/or specimen by parametric filtering the AE signals emitted by the structure and/or specimen as a function of parametric filters corresponding to characteristic waveforms of transient AE classes of predefined AE signals.

In another form, the invention includes a system for analyzing acoustic emission (AE) signals emitted by a structure and/or specimen comprising means for filtering the AE signals emitted by the structure and/or specimen as a function of parametric filters corresponding to characteristic waveforms of transient AE classes of predefined AE signals.

In another form, the invention includes a system for building from acoustic emission (AE) data parametric filters corresponding to different waveforms, comprising a first system for identifying one or more characteristic transient waveforms, a second system for identifying and/or extracting parametric AE data corresponding to the characteristic waveforms, and a third system for analyzing the parametric AE data in view of the identified waveforms to form parametric filters corresponding tot he identified waveforms.

In another form, the invention includes a method for building from acoustic emission (AE) data parametric filters corresponding to different waveforms, comprising identifying one or more characteristic transient waveforms, identifying and/or extracting parametric AE data corresponding to the characteristic waveforms, and analyzing the parametric AE data in view of the identified waveforms to form parametric filters corresponding tot he identified waveforms.

The method and system of the invention provide several advantages over the prior art including an improved capability of AE source type recognition; capability to detect, analyze, and monitor histories of different AE sources, e.g. various types of structural damage and fracture, leading to the improved life prediction and avoidance of the catastrophic failure; and to efficient nondestructive inspection and health monitoring; and smart structures capable of selectively responding to the detected damage, fracture, and other changes based on the type of these changes.

Other advantages and features will be in part apparent and in part pointed out hereinafter.

### BRIEF DESCRIPTION OF THE DRAWINGS

FIG. 1 is graph illustrating magnitude along the y axis and time along the x axis of a typical acoustic emission (AE) signal having parameters (rise time, decay time, count, duration) used in parametric analysis.

FIG. 2 is a block diagram of one preferred embodiment of the system and method according to the invention employing both AE parametric and transient analysis to identify characteristic AE waveshapes and to construct parametric filters for the identified waveshapes.

FIG. 3 is a block diagram of one preferred embodiment of the system and method according to the invention wherein the characteristic AE waveshapes for a specimen or structure are identified and wherein parametric filters for the identified waveshapes are constructed.

FIGS. 4A and 4B are block diagrams of one preferred embodiment of the system and method according to the invention wherein the constructed parametric filters are used in parametric AE analysis. FIG. 4A illustrates pre-recording filtering whereas FIG. 4B illustrates post-recording filtering.

FIG. 5 is a block diagram of one preferred embodiment of the system and method according to the invention wherein the constructed parametric filters are used in transient AE analysis.

Corresponding reference characters indicate corresponding parts throughout the drawings.

### DETAILED DESCRIPTION OF PREFERRED EMBODIMENTS

The invention is a system and method for nondestructive inspection and automated structural health monitoring (SHM). Such inspections tend to be a one-time event although the inspections may be repeated. On the other hand, SHM tends to be a continuous, on-line process. For example, a significant area of ongoing research and development efforts in the aerospace industry is the implementation of SHM using smart sensors and actuators integrated into the structure of an aerospace vehicle in order to provide a “built-in-test” (BIT) diagnostic capability for the structure. Such “smart structures” facilitate a reduction of acquisition and life cycle costs of aerospace vehicles which incorporate the same. Application of the invention in this context provides a reliable SHM which will enable the practice of condition-based maintenance (CBM), which can significantly reduce life cycle costs by eliminating unnecessary inspections, minimizing inspection time and effort, and extending the useful life of new and aging aerospace structural components.

A principal requirement of an integrated SHM is to provide a first level, qualitative damage detection, localization, and assessment capability which can signal the presence of structural damage and roughly localize the area where more precise quantitative non-destructive evaluation of the structure is needed. As will be pointed out below, the invention meets such a principal requirement.

The invention primarily relies upon acoustic emission monitoring of the structure and/or specimen under evaluation in order to detect any damage. In particular, the invention constitutes systems and methods for assessing the effect of at least one of a plurality of actions such as forces or other environmental changes acting upon a structure and/or specimen.

This invention also relates to systems employing sensors for collecting and interpreting data reflecting the effect of at least a selected one of a plurality of actions acting on a structure and/or specimen. In a further aspect the invention pertains to such systems and methods for assessing the integrity of a structure. In yet another aspect, the invention pertains to such systems for measuring loads applied to a structure and/or specimen or measuring the ability of a structure and/or specimen to carry designed loads. In still another aspect, the invention relates to such systems and methods which are employed to improve basic physical measurement schemes. In still another aspect, it pertains to such systems and methods which are applied to action detection. In yet another aspect, the system and method can be used with smart systems to detect damage or fracture and to respond to detected damage or fracture, such as by repairing or minimizing the damage or fracture.

As a specific example but not by way of limitation, the system and method of the invention may be used for locating a source of acoustic waves in a structural member such as an aircraft to detect structural defects therein. Structural defects such as stress cracks emit acoustic and stress waves which propagate outwardly therefrom. By embedding sensors in the aircraft structure and monitoring the structure for acoustic emissions, the inventions assists in the determination of the existence, type and location of defects such as stress cracks.

Since acoustic waves are ultrasound waves caused by micro seismic activity within a composition of matter, the system and method of the invention are applicable to inspecting or monitoring any physical arrangement or formation. For example, the invention may be used to inspect or monitor bridges since such acoustic emissions can be caused by fatigue crack growth, friction of crack surfaces, rubbing at connections, noise directly generated by traffic, impacts from masses or loose components, sudden movement of a structure or a defect, breaking of joints or bonds, and the like. The system and method also facilitate data analysis for such things as the acoustic event rate, event count, and other characteristics for the sources listed above. Also, the invention provides analysis for location of the source of the acoustic event based on the time of arrival of the ultrasonic wave from the same acoustic emission event at a number of different sensors.

Other examples in which the invention may be employed include the following:

1. NDE of ropes, cables, strands and pretensioned tendons (in concrete) for flaws and fractures;

2. predicting the destruction of bearing or other load bearing components by evaluating their AE signals;

3. inspection of cracks and welds in pipelines;

4. evaluation of cracking, pitting, high-cycle fatigue, and denting in metallic structures;

5. inspection of conduits for nuclear power generating and other plants;

6. inspection of inner-diameter cracks produced by intergranular stress-assisted corrosion cracking and by other causes in piping for nuclear power generating plants and other plants;

7. inspection of reactors and pressure vessels;

8. evaluation of inner-radius cracks in nozzles, control rods or other power plant structures; and

9. inspection of composite parts and structures.

The above are examples and not limitations as those skilled in the art will recognize that the invention may be applied to any inspection and/or monitoring.

The invention comprises a hybrid transient-parametric approach to analyzing AE signals by separating overall AE histories into the histories for different mechanisms/sources. The method and system of the invention are based on the combination of transient AE waveform analysis and parameter filtering. In one aspect, the invention is a method and/or system for establishing a link between parametric and transient AE analysis. The method and system of the invention apply, for example but not by way of limitation, to inspection and/or damage evolution analysis (e.g., health monitoring) of structures and/or specimens.

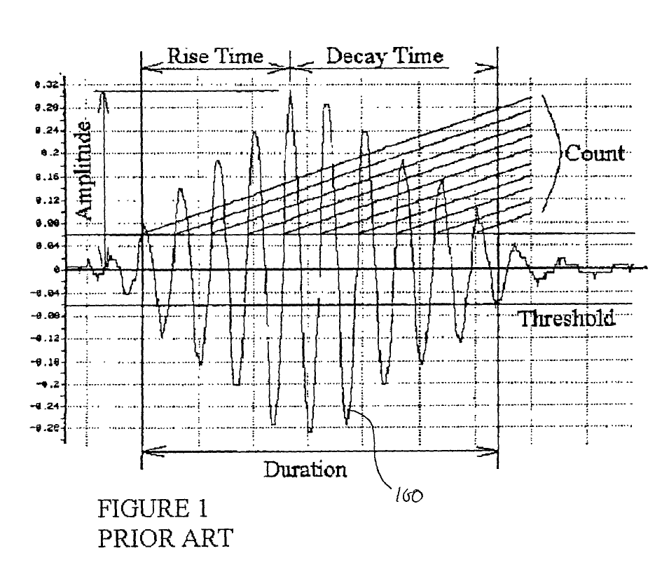

As noted above, FIG. 1 illustrates a typical acoustic emission (AE) signal 100 and its parameters/features: rise time, decay time, count, and/or duration used in parametric analysis.

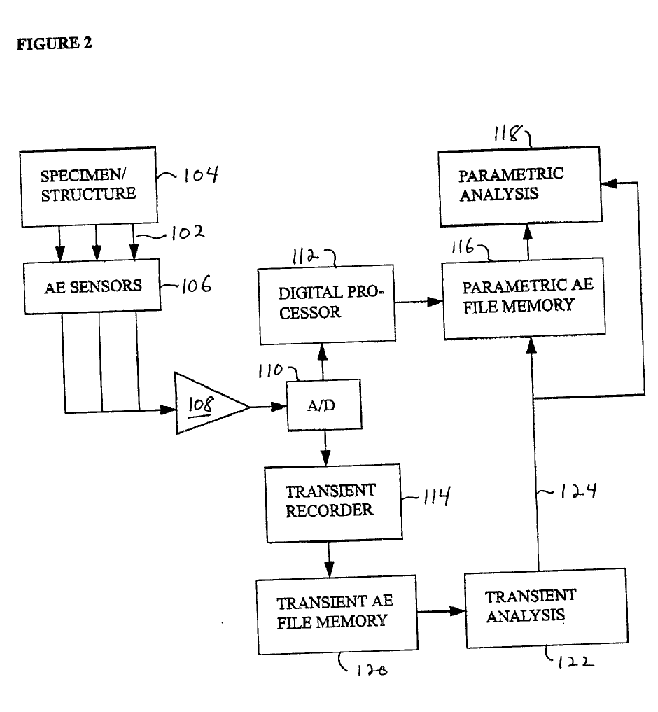

Referring to FIG. 2, a block diagram of a system according to the invention for processing signal 100 to build parametric filters is illustrated. FIG. 2 is a block diagram of one preferred embodiment of the system and method according to the invention employing both AE parametric and transient analysis to identify characteristic AE waveshapes and to construct parametric filters for the identified waveshapes. In general, the system and method include parametric filtering the AE signals emitted by a structure and/or specimen as a function of parametric filters corresponding to characteristic waveforms of transient AE classes of predefined AE signals. Predefined AE signals means any signals or class of signals which have been identified in advance, as noted below.

The parametric analysis phase is performed as follows. An ultrasonic or other acoustic wave 102 emitted by structures and/or specimens 104 caused by a source such as a physical damage event is detected by an AE sensor 106 such as an piezoelectric resonant sensor or a wideband sensor. In general, the source comprises any physical change such as a damage event, fracture progression, friction, impact, force application, external damage or any other source which results in physical change causing the AE signals.

The sensor 106 converts the mechanical vibration into an analog signal. The signal is conditioned by a preamplifier circuit 108 and digitized by an A/D converter 110. The digitized signal is provided to a digital processor 112 and a transient recorder 114. The processor 112 electronically extracts a number of parameters/features for each AE event. These AE parameters/features along with some additional information, such as time of arrival, and some external parameters, such as current load, are recorded into a parametric AE file memory 116. Parametric analysis of the recorded information, as indicated by block 118, may be conducted by a computer or algorithm while the AE signal itself is discarded in this parametric AE analysis phase 118. An advantage of the parametric analysis method is its simplicity. AE systems provide powerful analysis and filtering capabilities for the AE parameters/features. AE histories, statistical distributions, and correlations can be generated and studied. Cluster analysis can be performed. AE location information can be extracted from the data from two or more sensors.

The transient AE analysis phase is performed as follows. In transient analysis, full, digitized waveforms of the AE signals are recorded and analyzed by the transient recorder 114. Transient analysis requires additional hardware compared to parametric analysis, i.e., a transient recorder 116. The results of the transient acquisition are recorded by the AE system into a transient AE file memory 120. This file typically contains a list of digitized AE signals (wave signatures) in the order they have been received by the system. AE systems provide powerful advanced signal analysis capabilities. Wave frequency spectra can be calculated and analyzed. Additional AE parameters can be extracted, for example peak frequency, spectral moments, etc. Custom defined parameters can be calculated. Thereafter, transient analysis as indicated by block 122 is conducted.

The type of AE sensors 106 used in the analysis is important for the transient analysis. A wideband sensor is usually preferred to a resonant sensor for transient analysis because the wideband sensor produces less distortion of the shape of the acquired signal. It should be noted that the same or substantially similar sensors should be used for the investigation in both the parametric and transient analysis.

One purpose of the transient AE analysis phase is to generate characteristic AE waveforms which are used to define parameter filters stored as a reference. One way to generate such characteristic AE waveforms is by use of a reference structures and/or specimens 104. The reference structures and/or specimens generate AE reference signals caused by and corresponding to a known source to which the reference structures and/or specimens is subjected. The AE reference signals are detected by using wideband sensors as part of the sensor array 106. The reference signals are amplified by amplifier 108 and digitized by the A/D converter 110. The digitized AE reference signals are stored by the transient recorder 114 in the transient AE file memory 118. The characteristic waveforms are evaluated and stored in the transient AE file memory 120 to define a set of one or more single parameter filter or multiparameter filters corresponding to each of the characteristic AE waveforms. The filters are stored as a reference. Thereafter, when the system of FIG. 2 is analyzing the AE signals emitted by structures and/or specimens 104 (not reference structures and/or specimens) wherein the AE signals are caused by a change in the structures and/or specimens 104, the filter set is applied to parameters of the AE signals as indicated by line 124 to accomplish either pre- or post-recording filtering to determine a correlation between on of the know sources and the AE signals emitted by the structures and/or specimens 104.

The filters may filter the AE signals according to one or more of the following parameters: signal amplitude, duration, rise time, decay time, AE counts, average frequency, energy, signal shape, peak frequency, spectral moments and/or custom defined calculated parameters.

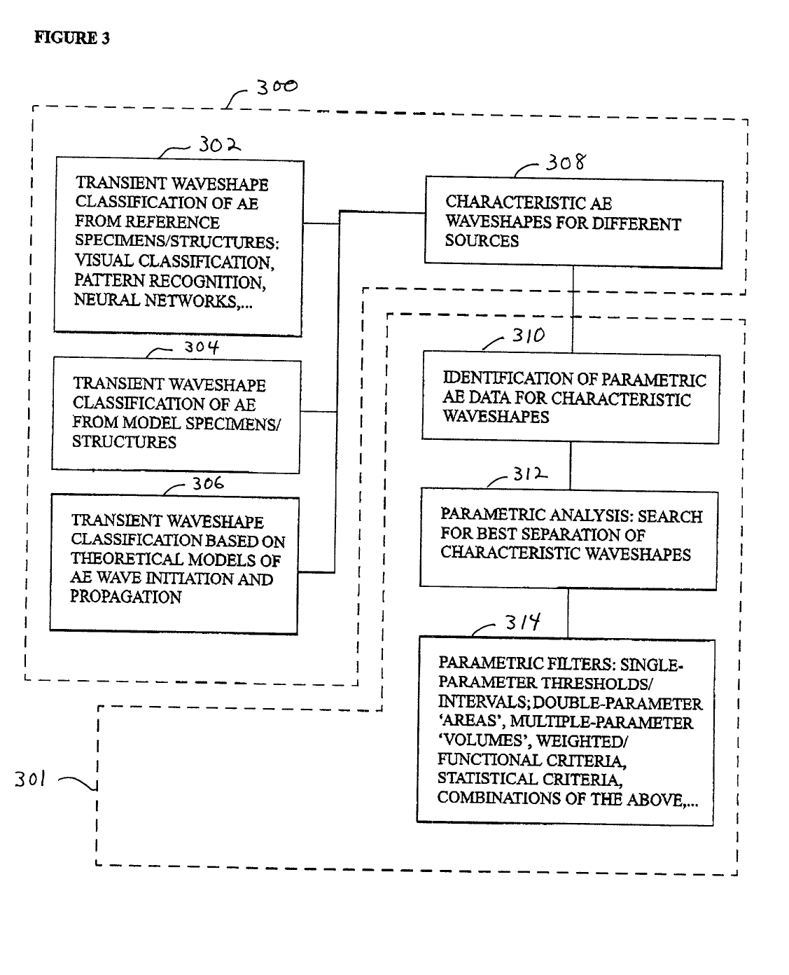

Referring to FIG. 3, a block diagram of one preferred embodiment of the system and method according to the invention is illustrated for building the filters wherein, in a first process 300, the characteristic AE waveshapes for a specimen or structure are identified and wherein, in a second process 301, the parametric filters for the identified waveshapes are constructed.

The first process 300 can be with or without explicit determination of physical sources. The implementation without determination of physical sources can use any formal method of signal classification: visual screening of signals and/or their spectra; methods of pattern recognition, etc. The result would be characteristic waveshapes from different but unknown sources (useful, e.g., in studying entirely new structures and/or specimens, etc).

In the embodiment illustrated in FIG. 3, a determination of characteristic waveshapes corresponding to physical sources may be done by transient waveshape classification of AE (1) from reference specimen/structures as indicated by block 302, (2) from model specimens/structures as indicated by block 304 and/or (3) from theoretical models of wave initiation and propagation as indicated by block 306. In any case, the result is characteristic AE waveshapes per block 308 corresponding to one or more different sources.

For reference specimen/structure classification per block 302, a reference structure/specimen similar to an actual specimen/structure to be monitored/evaluated is initially used. Similarity would normally include loading and/or other ‘action’ causing AE (same type of load/action during reference testing as during monitored service or NDE evaluation of actual structures/specimens). It should be noted that, for expensive structures/specimens, the reference structure/specimen may be the actual structure/specimen loaded not to failure. This approach includes comparing the classified characteristic waveshapes with independent observations of the sources (e.g. by visual inspection or other NDE methods, etc.).

For model structure/specimen classification per block 304, either a modified structure/specimen or an actual structure/specimen subjected to a modified load/action that would excite particular physical sources of AE (natural excitation) and produce characteristic AE waveforms is initially used. The model structures/specimens can also be used with simulated, artificial, and/or externally triggered AE sources (artificial excitation). For example, simplified ‘model’ structures and/or specimens that excite and/or produce only particular physical AE sources can be used as indicated by block 304.

For theoretical model structure/specimen classification per block 306, a theoretical model of a structure/specimen is initially used. The model is a mathematical or numerical model (e.g. a finite element model) that describes or simulates AE sources and resulting wave phenomena in an actual structure/specimen that cause AE sensor vibrations detected and analyzed by an AE system. For example, theoretical and/or numerical simulations of waves from different sources can be employed.

There are many ways for reference specimen/structure classification per block 302, and for the whole hybrid transient-parametric analysis, according to the present invention. For example, an automated pattern recognition analysis, with or without explicit identification of physical sources of characteristic waveshapes, may be employed. The latter analysis (without explicit identification of physical sources) is still consistent and the title of this invention as the characteristic waveshapes are normally produced by different sources, even if they are not known. The expression “different sources” should be treated broadly. Using structural damage as an example, different sources may include cracks of different size, location, orientation; cracks produced under different loading or environmental conditions; cracks produced in different parts/constituents of a composite structure and/or parts of structure loaded to a different level (e.g. structural corners, holes, joints, etc); new cracks or crack extensions and coalescence; combinations of the above, etc.

One advantage of reference specimen/structure classification per block 302 is similarity of the reference testing conditions and the actual monitoring or evaluation conditions. The ensemble of the waveshapes from the reference test, and the classified characteristic waveshapes, would therefore directly correspond to the AE from the monitored/evaluated system. Note: the physical sources of the characteristic waveshapes can be identified as a result of the analysis by the proposed hybrid method, e.g. by comparing the classified AE with independently observed physical changes in the tested structure/specimen.

The other two classification methods per blocks 304 and 306 would normally produce a link between the characteristic waveshapes and physical sources. These two methods are also good for establishing the ranges of variability (sensitivity) of signals from different sources due to variations in some test parameters, e.g. employing neural network methods, etc. However, due to the simulated nature of the test/specimen/source, the waveshapes in these methods can differ to an extent from the waveshapes in actual tests. In this case, a preferred approach may be to combine the methods of blocks 302, 304 and 306 in a complimentary fashion.

In any approach, neural networks may be used to take into account the variability of signals due to changes in their source location, structures and/or specimens geometry, etc. The result of the first process 300 would be one or several characteristic AE waveshapes per block 308 with or without explicitly known physical source(s). It is expected that the overall transient record from a ‘real’ (not model) specimen and/or structure, will also contain unclassified, random signals, along with the classified characteristic signals. These unclassified signals may be due to many reasons, e.g. due to complicated and/or random wave transformations during propagation from random locations; due to unfrequent and/or random physical sources; due to overlap of signals from several sources and/or events, etc. The relative content of these signals will depend on particular part, its geometry, test conditions, etc.

The second process 301 can be applied on the parametric AE data collected and recorded simultaneously with the transient data analyzed in first process 300. It involves a subprocess 310 which is the identification of parametric AE data for different waveshapes. This subprocess 310 can be performed by a variety of methods either manually or, in a preferred embodiment, automatically (or semi-automatically). The latter can be done, e.g., by utilizing a ‘transient’ index in the parametric data sets (some AE systems provide this), by time sequencing, etc. Alternatively, the parametric data can be obtained directly from the classified transient signals by their parametric ‘post’ analysis. The parametric datasets for different characteristic waveforms can be marked in various ways, e.g. by employing an additional alphanumerical marker and/or flag, etc. The process 301 also includes a subprocess of searching for parametric filters providing a preferred signal separation 314.

Once the parametric data for different characteristic waveforms is identified, a subprocess 312 includes the construction of parametric filters 314. These filters can be of a variety of different types, e.g. single parameter thresholds/intervals, double parameter ‘areas’ in the two-parameter spaces, multiparameter ‘volumes’ in three-parameter spaces and generalized ‘volumes’ in parametric spaces of higher dimensionality, filters involving weighed functional criteria such as various weighing coefficients and/or parametric functional criteria, statistical criteria, and various combinations of the above, etc. These filters can be built by many different methods, e.g. by ‘manual’ plotting and analysis of parametric distributions and correlations, by various semi-automatic or automatic procedures, e.g. screening, optimization, procedures involving non-linear analysis, cluster analysis, etc. Different types of filters can be used for different characteristic waveshapes, e.g. a single-parameter threshold for one waveshape and an area in a two-parameter space for another waveshape, etc. The filters for several different waveshapes can be used on the overall parametric AE data containing AE from all sources, or sequentially, when each consecutive filter is used on the AE data remaining after the previous filter applications.

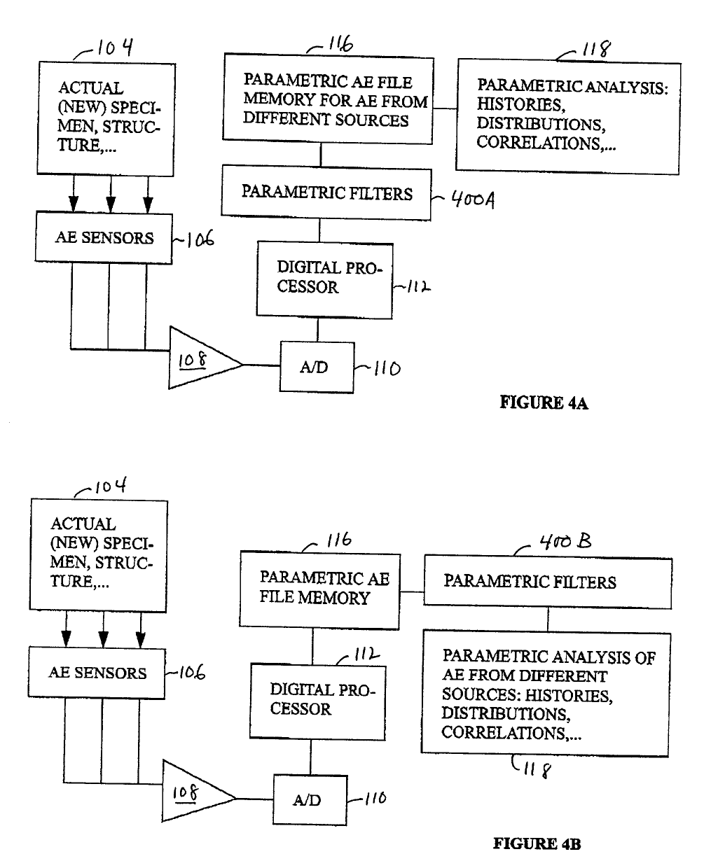

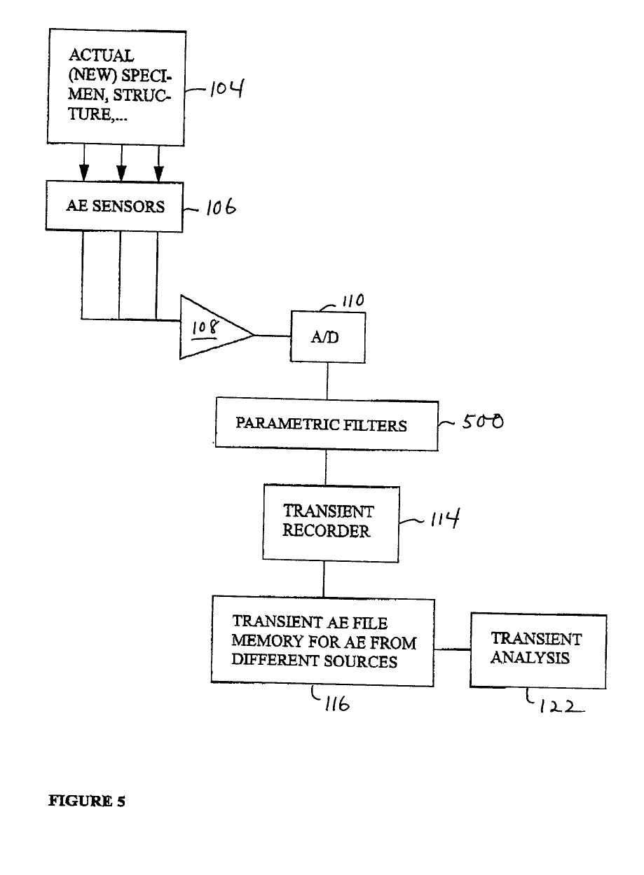

It is expected that various filters will have different efficiency. Different criteria for the filter efficiency can be used for final filter selection, e.g., high percentage of signals with correct characteristic shapes, low percentage of signals of all or particular other (incorrect) characteristic shape, low percentage of unclassified signals, etc. The filters for unclassified signals can be built using the same methodology. The result of the second process 301 would be a set of parametric filter definitions 314 that can be documented and stored for future analysis of the same or other, similar structures and/or specimens. The filters can be also built based on the analysis of a group of specimens and/or structures. Alternatively, the filters built for a particular specimen and/or structure may be applicable to related but different specimens and/or structures. The filter transferability can be studied and/or proven by a separate analysis.

Whereas FIGS. 2 and 3 relate to the building of the filters according to the invention, the following FIGS. 4A, 4B and 5 relate to use of the filters obtained from the method and system of FIGS. 2 and 3. Preferably, the same or substantially similar conditions as possible should be employed in the use of the filters as in the building. For example, it would be preferable to use the same sensors, the same acoustic acquisition parameters and the acoustic emission monitoring conditions.

Referring to FIGS. 4A and 4B, block diagrams of one preferred embodiment of the system and method according to the invention wherein the constructed parametric filters are used in parametric AE analysis is illustrated. As shown in FIG. 4A, the parametric filters 400A are applied for pre-recording filtering so that the filters are employed before the process of creating the parametric AE file memory 116 and before the parametric analysis 118. Alternatively, as shown in FIG. 4B, the parametric filters 400B are applied for post-recording filtering so that the filters are employed after the process of creating the parametric AE file memory 116 and before the parametric analysis 118. In either case, the filter-identified characteristic AE datasets can be extracted and/or marked for future analysis. One main purpose of the systems and methods of FIGS. 4A and 4B are the real time monitoring of signal histories in order to detect or predict the presence of damage or fracture or the dangerous evolution of damage or fracture. The configuration of FIG. 5 is for prefiltering of transient AE signals so that only AE signals from desired sources are saved.

The filters can also be applied on transient data. FIG. 5 is a block diagram of one preferred embodiment of the system and method according to the invention wherein the constructed parametric filters are used in transient AE analysis. In this configuration, the parametric filters 500 are applied before the recording by the transient recorder 114. This would eliminate complicated pattern recognition analysis which usually requires special software and/or experience.

As noted above, it is preferable to use the same sensors, acquisition parameters and monitoring conditions in the FIGS. 4 and 5 configurations as used in the reference tests. In addition, the same type of sensors are used for both transient and parametric analysis according to FIG. 5; either resonant or wideband sensors are used and such sensors are not interchangeable. It is also contemplated that the filter definitions can be documented along with the waveshapes (‘signatures’) and along with the test conditions (e.g., structures and/or specimens geometry, sensors, AE system parameters, etc.).

Ultimately, the results of the above method can be used for detailed analysis of the processes, prediction of their evolution, mechanism-based life prediction of structures and/or specimens, etc.

In general, the following is one preferred embodiment of the method according to the invention. In step 1, transient classification is done by an automated pattern recognition of AE waveshapes from one or more reference systems. Physical sources of the characteristic waveshapes and their variability /sensitivity to particular test conditions are evaluated by correlating the results with transient analysis of AE from one or more model physical systems and/or theoretical or numerical models. In step 2, parametric data records for different characteristic AE waveshapes obtained in step 1 are extracted from the overall parametric AE automatically, e.g. by using a transient index. In step 3, parametric analysis for preferred parametric filters to separate AE from different sources is performed semi-automatically or automatically using a predefined set of filter types (e.g. filter types of gradually increasing complexity). The preferred separation for each particular filter type is determined based on a predefined statistical criterion. One or several preferred overall filters are selected among the preferred filters of each type based on a predefined statistical criterion. The preferred filter or several filters are catalogued along with the typical characteristic waveshapes and the information on the tested system, AE test parameters, applied loading (action), environmental conditions, etc. In step 4, the preferred filter or several filters from step 3 are used to monitor/evaluate actual specimens as described above and in FIGS. 4A, 4B and 5.

In general, the following is one preferred embodiment of the system according to the invention. Steps 1-3 above are implemented in software working in conjunction with AE hardware capable of simultaneous transient and parametric AE record and analysis. The analysis according to steps 1-3 is done either automatically or semi-automatically, with an interactive input from an operator (preferred). The preferred filter definitions from the step 3 are further used in the step 4 on an actually monitored and/or evaluated system (specimen/structure) by utilizing the same or different AE system. The latter can be a simplified (e.g. parametric-only) system. The filter definitions in such a monitoring/evaluating system are upgradeable and can be changed, e.g. by means of extractable cartridges (flash memory cartridges, etc), by connection to the electronic data-base containing the results of the step 3, etc.

In general, the following is one preferred embodiment of the system according to the invention for a health monitoring/nondestructive evaluation system. Such a system includes a network of similar systems with AE sensors permanently installed/embedded in the actually evaluated structures/specimens according to the step 4, that are connected to a mother system performing the reference analysis according to the steps 1-3.

In another form, the invention includes a method for building from acoustic emission (AE) data sets parametric filters corresponding to different waveforms. This is accomplished, as noted above by first analyzing the AE data sets and, second, by identifying one or more waveforms corresponding to the analyzed AE data sets.

In another form, the invention includes a system for building from acoustic emission (AE) data sets parametric filters corresponding to different waveforms. This is accomplished, as noted above by a first system for analyzing the AE data sets and by a second system for identifying one or more waveforms corresponding to the analyzed AE data sets.

Analysis of Composite Materials

The following discussion relates to the analysis of composites and applies the above invention with respect to the specific issue of a method and system to distinguish and analyze sources of acoustic emission in composites. However, it is contemplated that the invention may be used in any system or method in which the integrity of structures and/or materials is monitored or evaluated.

The monitoring of fatigue damage in advanced composite materials is of particular interest in the field of structural analysis. Whereas homogeneous engineering structures and/or specimens subjected to loads usually fail as a result of critical crack propagation, advanced composite materials, in contrast, exhibit gradual damage accumulation to failure. Damage development in composites starts early in the loading process due to the inherent inhomogeneity of these materials. Advanced composite materials consist of reinforcing elements, such as fibers, embedded in a matrix. The reinforcing elements are stiff and strong, and often exhibit substantial anisotropy of mechanical properties. The matrix material, on the other hand, is usually soft and isotropic. An external load applied to such a composite results in severely inhomogeneous stress and strain fields. Early damage starts to develop in the microvolumes within the composite in which the localized stress has reached the strength or fracture limit of a particular constituent or an interface between the constituents. The resulting crack sizes correlate with the sizes of material inhomogeneities responsible for the stress inhomogeneity. The microcracks that develop are usually too small to cause final failure of the composite. A substantial number of these microcracks accumulate in the composite before failure.

Were it not for the inherent randomness of composite microstructure and properties, the microcracks of a particular type would all occur in the repeating volumes of the material at the same load. However, the microstructure of composites is random at the microscale. Parameters, such as volume fraction and orientation of fibers, ply thickness, the localized fiber spacing and packing often exhibit wide statistical variations, when evaluated at the microscale. Therefore, some localized microvolumes in the composite are always stressed more than others. The stress inhomogeneity is further enhanced by the inhomogeneity of the elastic properties of the composite constituents. The inhomogeneity of the stress field, coupled with the inhomogeneity of the strength and fracture properties of the reinforcing elements, the matrix, and the interface, lead to the gradual damage development in composites. As a result, the overall failure process in composites is often viewed as a process of formation, accumulation, and coalescence of damages of different types.

Many damage micromechanisms can be observed in composites. For advanced fiber-reinforced composites laminates, the most typical damage mechanisms are matrix cracks, fiber breaks, and delaminations. The characteristic size of matrix cracks and fiber breaks is small. The characteristic size of delamination is larger than that of the matrix cracks and the fiber breaks. As a result, the delamination damage is sometimes referred to as “macrodamage.” However, even the delamination “macrocracks” are typically small in size when compared to the structural level damage. the word “macrodamage” will be used herein in a relative sense in order to distinguish damage mechanisms that have characteristic sizes larger than those for typical matrix and fiber damage.

Studies of mechanisms and histories of damage in composites provide better understanding of their ultimate failure and life. Theoretical analyses of damage evolution in composites were performed by many authors. For example, a continuum damage mechanics approach has been applied. Elaborate analyses were also conducted to evaluate the effects of damage on stiffness characteristics. The stochastic nature of gradual damage accumulation in composites was explicitly taken into account in statistical models of damage accumulation in composites developed. The models predicted gradual damage accumulation of different types under various loads. Development and verification of the theoretical models of damage evolution in composites require experimental studies of damage development in these materials.

Experimental analysis of damage evolution in composites is not easy, however. A number of nondestructive evaluation (NDE) techniques were applied for this purpose. These included thermography, eddy current, optical holography, radiography, X-ray, tomography, ultrasonic resonance, pulse-echo, and through-transmission techniques. The majority of these methods were capable of detecting larger individual flaws and delaminations in composites. However, the characteristic sizes of the matrix cracks, fiber breaks, fiber-matrix disbonds, and ply-damage induced delaminations were usually too small for these defects to be detected by the conventional NDE techniques. A method that was shown capable of real time damage monitoring in composites is acoustic emission (AE) analysis. In this method, ultrasonic waves generated by the rapid release of elastic strain energy during damage events are detected and analyzed.

Parametric and transient methods of AE analysis have been found to provide some information in limited applications. On one hand, the parametric method may be effective for analyzing histories because it acquires little data and it is easy to plot and/or analyze. However, the parametric method is not good for source recognition because of parametric overlaps and because there may be no distinguished clusters in multiparameter spaces. On the other hand, the transient method can more effectively recognize different sources because full waveshapes from different sources can be distinguished notwithstanding their parametric overlap. However, the transient method is not good for analyzing histories because it requires high data volume and is difficult to plot resulting in the additional need to extract parameters for history analysis. Also, transient classification itself (e.g. by visual screening or pattern recognition, etc.) and/or identification of sources for different characteristic waveshapes (e.g. by independent observations of actual events causing AE; by testing simplified ‘model’ specimens producing only particular sources; by modeling ultrasonic waves from various sources; etc.) is very time consuming and complicated. So far, transient classification was mostly done on the overall accumulated AE, without extracting the histories for different AE sources. AE histories for different sources can be very important and are critical for the analysis, life prediction, etc.

The following is a specific example wherein the above invention is applied to analysis of composite materials.

The composite materials used in this example were manufactured from Hexcel T2G-190-12-F263 graphite-epoxy unidirectional prepreg tape. Laminated panels were assembled following hand lay-up procedure and cured in a two-chamber press-clave under controlled temperature, pressure and vacuum environments. The manufacturer recommended curing cycle was applied. Four composite lay-ups were used in this study: two unidirectional composites, [0]₈ and [90]₁₆, a cross-ply composite [0/90]_{3S}, and an angle-ply composite [±45]_{4S}. The cured panels were tabbed using strips of a commercial glass fiber woven composite. The tabbing prevented premature failure of composites and reduced acoustic noise from grips. The specimen length was in the range from 200 to 250 mm. The specimen width was 25 mm for the [90]₁₆ composite, 20 mm for the [±45]_{4S} composite, and 15 mm for the [0]₈ and [0/90]_{3S} composites. The specimen thickness was determined by the lay-up and varied from 1.48 mm for the unidirectional [0]₈ composite to 2.86 mm for the angle-ply composite.

Tensile mechanical testing was performed by a servo-hydraulic MTS testing machine digitally controlled with an Instron test control and data acquisition system. All quasi-static tests were performed under stroke control with Instron 8500 software. The displacement rates used were 0.5 mm/min for the [0]₈ composite, 0.1 mm/min for the [90]₁₆ composite, and 0.3 mm/min for the laminated composites. A uniaxial ITS 632 extensiometer and a biaxial Instron 2620 extensiometer were used for strain measurement. The axial gauge length was 25 mm. The specimens were clamped with serrated wedge action grips. Special care was exercised while installing specimens within the grips to ensure alignment. Additional alignment was provided by a Satec spherical alignment coupling. Several specimens of each of the aforementioned types were tested in tension. Both biaxial and uniaxial extensiometers were used.

A two-channel AMS3 AE system by Vallen Systeme, GmbH was used for acoustic emission (AE) analysis. Each AE channel was connected to a preamplifier attached to an AE sensor. AE events were acquired by the sensor as analog signals. They were preamplified and converted into digital signals by an A/D converter. The AE signal parameters were then extracted by the system, augmented with time of arrival and external parameters (load and strain), and recorded in a parametric AE file. The system was equipped with a transient recorder. In parallel with the AE parameter acquisition, full, digitized waveforms of the AE events were acquired by the transient recorder and recorded in a separate transient AE file. Each AE waveform was assigned a unique transient index. This index was stored as one of the parameters in the parametric AE record, providing the capability to establish the correspondence between the waveforms and the parametric records in the two files.

Two wide-band, high fidelity B1025 AE sensors by Digital Wave were used in the analysis. The sensors were mounted on the specimen by means of tape. Vaseline was used as a coupling agent between the sensor and the composite surface. The effect of sensor attachment force was investigated using an ultrasonic pulser. An imitation AE signal was generated by the pulser, transmitted from one sensor to another, and analyzed by the AMS3 system. It was found that the variation of parameters of the transmitted signals became saturated when the attachment force reached the level of about 10 N. Consequently, a force of 10 N was used in all AE experiments.

The AE gauge zone (the distance between the AE sensors) was 60 mm for the [90]₁₆ composite and 80 mm for all other composites. The AE source location analysis was performed on the incoming signals and the signals originating outside the acoustic gage zone were filtered out in order to reduce the acoustic noise generated by the testing machine ad grips.

A 34.5 dB system gain and a 40.5 dB threshold were used for the AE acquisition. The AE data acquisition was initiated simultaneously with mechanical loading. The acoustic emission was thus recorded from the beginning of the test to the final failure of the specimen. The information on load and strain was continuously fed from the Instron 8500 system to the AMS3 system. This information was stored in the parametric AE record and allowed to correlate the AE parameters with the load and strain at the time the AE signal was produced.

As a result of each test, two data files were generated for each specimen, the parametric file and the transient file. The former contained a list of parametric data records. The latter contained a list of digitized waveforms. The AMS3 software provided powerful filtering and waveform analysis capabilities that were used for AE data analysis after the tests were completed.

Results/Conclusions

Three characteristic AE waveforms with different frequency spectra were identified based on the transient analysis. Regions occupied by these waveforms in the amplitude-risetime parametric space were identified for the [0]₈ and [90]₁₆ unidirectional composites. Multiparameter filtering was applied to extract evolution histories for the characteristic waveforms. The results were compared with actual damage in the specimens and the three characteristic AE waveforms were associated with matrix cracks, fiber breaks, and ‘macrodamage’, such as delaminations or longitudinal splitting in unidirectional plies. The multiparameter filters based on the analysis of the unidirectional composites were used to extract the damage evolution histories for the cross-ply [0/90]_{3S} and angle-ply [±45]_{4S} composites. The results compared favorably with the observed damage in these materials. An inverse analysis of the quality of the multiparameter filtering for the laminated composites indicated that the filters developed for unidirectional composites can be applied to the analysis of laminated composites with reasonable reliability.

The example illustrates that the hybrid method and system of the invention combines the power of the transient AE classification with the relative simplicity of the parametric filtering and enables the separation of the AE signals from different damage actions by parameter filtering. The example also shows correlation between the results of acoustic analysis and physical observations.

It should be noted that the characteristic waveforms and the parametric regions occupied by these waveforms are expected to vary from one material to another, and a separate analysis should be performed for each particular composite system. The generality of the characteristic waveforms and the parametric regions observed indicate the transferability of the parametric filters among different composite lay-ups within the same material family.

Since the parameter filtering procedure and system of the invention requires only parametric AE data, it is expected that the invention will be advantageous for studying fatigue damage histories in composites or other specimens and/or structures where the full transient waveform analysis may be prohibitive or impractical.

In view of the above, it can be seen that the several objects of the invention are achieved and other advantageous results attained.

As various changes could be made in the above systems and methods without departing from the scope of the invention, it is intended that all matter contained in the above description and shown in the accompanying drawings shall be interpreted as illustrative and not in a limiting sense.

What is claimed is:

1. A method of analyzing acoustic emission (AE) signals emitted by a structure and/or specimen comprising:
parametric filtering the AE signals emitted by the structure and/or specimen as a function of parametric filters corresponding to characteristic waveforms of transient AE classes of predefined AE signals.

2. The method of claim 1 for nondestructively inspecting a structure and/or specimen or for health monitoring of a structure and/or specimen.

3. The method of claim 1 for use in combination with a smart system for detecting damage or fracture and for responding to the detected damage or fracture.

4. A method of analyzing acoustic emission (AE) signals emitted by a structure and/or specimen as compared to AE signals emitted by reference structures and/or specimens comprising:
identifying characteristic AE waveforms based on transient analysis of the AE signals emitted by the reference structures and/or specimens;
defining one or more parameter filters corresponding to the characteristic waveforms; and
applying the defined parameter filters to the AE signals emitted by the structure and/or specimen.

5. The method of claim 4 wherein the step of identifying comprises one or more of the following:
classifying transient waveshapes of AE signals from a reference specimens and/or structures such as by pattern recognition; and/or
classifying transient waveshapes from model specimens and/or structures; and/or
classifying transient waveshapes from theoretical models of specimens and/or structures.

6. The method of claim 5 wherein the classifying steps includes processing by a neural network.

7. The method of claim 4 wherein the defining step includes searching for the filter providing the preferred signal separation.

8. The method of claims 1 or 4 wherein the filters comprise one or more of the following: single parameter filters, two parameter filters, three or more parameter filters, weighted criteria filters, and/or functional criteria filters.

9. The method of claims 1 or 4 wherein the filters filter the AE signals according to one or more of the following parameters: signal amplitude, duration, rise time, decay time, AE counts, average frequency, energy, signal shape, peak frequency, spectral moments and/or custom defined calculated parameters and/or features.

10. The method of claims 1 or 4 wherein characteristic AE waveforms are identified corresponding to different types of damage or fracture in the reference structures and/or specimens.

11. The method of claims 1 or 4 further comprising:
acquiring parametric and transient AE data from the AE signals emitted by the reference specimens and/or structures;
identifying characteristic waveforms by transient analysis of the acquired data;
identifying from the acquired parametric AE data parametric data records corresponding to the characteristic waveforms from different sources;
defining parametric filters based on the identified parametric data records; and
applying the defined parameter filter to the AE parametric data from the AE signals emitted by the structure and/or specimen.

12. The method of claim 11 wherein the defined parameter filter are applied as pre-recording filters applied to acquire the parametric AE data stored in a parametric AE file memory of AE signals resulting from different sources.

13. The method of claim 11 wherein the defined parameter filter are applied as post-recording filters applied to the acquired parametric AE data.

14. The method of claim 11 wherein the defined parameter filter are applied to the AE signals prior to transient recording of the transient AE signals.

15. A method of analyzing acoustic emission (AE) signals emitted by a structure and/or specimen wherein the AE signals are caused by a change in the structure and/or specimen due to an unknown source, said method comprising:
providing AE reference signals emitted by reference specimens and/or structures wherein each AE reference signal is caused by and corresponds to a change in the reference specimens and/or structures due to a known source;
identifying a characteristic AE waveform corresponding to the known source based on transient AE classification of the AE reference signals emitted by reference structures and/or specimens;
defining a set of one or more parameter filters corresponding to the characteristic AE waveform; and
applying the defined parameter filter set to parameters of the AE signals emitted by the structure and/or specimen to determine a correlation between the known reference sources and AE signals emitted by the structure and/or specimen.

16. The method of claim 15 wherein the identifying is performed by or in conjunction with a pattern recognition and/or neural network.

17. The method of claim 15 wherein the known source comprises a physical change such as a damage event, fracture progression, friction, impact, force application, external damage or any other source which results in physical change causing the AE reference signals.

18. A method of analyzing acoustic emission (AE) signals emitted by a structure and/or specimen comprising:
identifying characteristic AE waveforms based on transient analysis of AE signals;
constructing one or more parameter filters corresponding to the characteristic AE waveforms; and
applying the constructed parameter filters to extract and analyze the evolution histories of the AE signals emitted by the structure and/or specimen.

19. A system for analyzing acoustic emission (AE) signals emitted by a structure and/or specimen comprising:
means for filtering the AE signals emitted by the structure and/or specimen as a function of parametric filters corresponding to characteristic waveforms of transient AE classes of predefined AE signals.

20. The system of claim 19 for nondestructively inspecting a structure and/or specimen or for health monitoring of a structure and/or specimen.

21. The system of claim 19 comprising a smart system for detecting damage or fracture and for responding to the detected damage or fracture.

22. The system of claim 19 wherein the means for filtering comprises software adapted to be executed by a digital processor.

23. A system for analyzing acoustic emission (AE) signals emitted by a structure and/or specimen as compared to AE signals emitted by reference structures and/or specimens comprising:
means for identifying characteristic AE waveforms based on transient analysis of the AE signals emitted by the reference structures and/or specimens;
means for defining one or more parameter filters corresponding to the characteristic waveforms; and
means for applying the defined parameter filters to the AE signals emitted by the structure and/or specimen.

24. A system for analyzing acoustic emission (AE) signals emitted by a structure and/or specimen comprising:
means for identifying characteristic AE waveforms based on transient analysis of AE signals;
means for constructing one or more parameter filters corresponding to the characteristic AE waveforms; and
means for applying the constructed parameter filters to the AE signals emitted by the structure and/or specimen.

25. A computer readable medium having computer executable instructions for performing the method of claims 1, 4, 15 or 18.

26. A method for building from acoustic emission (AE) data parametric filters corresponding to different classified waveforms comprising:
classifying transient AE waveforms by transient analysis;
identifying and/or extracting parametric AE data sets corresponding to different classified waveforms; and
analyzing the identified AE data sets in conjunction with the overall AE data to find parametric filters for preferred separation of the identified sets from the overall AE.

27. The method of claim 26 wherein the identifying step is performed from the parametric AE data acquired simultaneously with the transient AE data used in the classifying step by utilizing transient index and one or several of the following:
marking parametric AE records corresponding to different classified AE waveforms using a special flag or parameter;
creating lists of transient indices for parametric AE records corresponding to different classified AE waveforms; and
extracting parametric AE records corresponding to different classified AE waveforms from the overall AE and recording the extracted AE records into separate parametric files.

28. The method of claim 26 wherein the identifying step is performed by extracting the parametric AE data from the transient AE data used in the classifying step by utilizing post-parametric analysis of the recorded transient waveforms.

29. A system for building parametric filters corresponding to different classified waveforms from acoustic emission (AE) data comprising:
means for classifying transient AE waveforms by transient analysis;
means for identifying and/or extracting parametric AE data sets corresponding to different classified waveforms; and
means for analyzing the identified AE data sets in conjunction with the overall AE data to find parametric filters for preferred separation of the identified sets from the overall AE.

30. The system of claim 29 wherein the means for identifying performed from the parametric AE data acquired simultaneously with the transient AE data used in the means for classifying by utilizing transient index and one or several of the following:
means for marking parametric AE records corresponding to different classified AE waveforms using a special flag or parameter;
means for creating lists of transient indices for parametric AE records corresponding to different classified AE waveforms; and
means for extracting parametric AE records corresponding to different classified AE waveforms from the overall AE and recording the extracted AE records into separate parametric files.

31. The system of claim 29 wherein the means for identifying step is performed by extracting the parametric AE data from the transient AE data used in the means for classifying by utilizing post-parametric analysis of the recorded transient waveforms.
